(19) United States
(12) Patent Application Publication
(10) Pub. No.: US 2022/0167543 A1
(43) Pub. Date: Jun. 2, 2022

(54) SYSTEM AND METHOD FOR IMPLEMENTING END-OF-ROW TURNS WITH AGRICULTURAL VEHICLES

(71) Applicant: CNH Industrial America LLC, New Holland, PA (US)

(72) Inventors: Brent David Bast, Sioux Falls, SD (US); Nathan Paul Brooks, Manitowoc, WI (US); Steven Winkel, Elkhart Lake, WI (US)

(73) Assignee: CNH Industrial America LLC

(21) Appl. No.: 17/109,846

(22) Filed: Dec. 2, 2020

(51) Int. Cl. A01B 69/04; G05D 1/02

(52) U.S. Cl. CPC A01B 69/008; G05D 2201/0201; G05D 1/0223

(57) ABSTRACT

A method for implementing end-of-row (EOR) turns within a field may include receiving a selection of a selected EOR turn path type of a plurality of EOR turn path types associated with executing EOR turns within the field. The method may further include controlling an operation of the agricultural vehicle to traverse a first path extending across the field during the performance of an agricultural operation. Moreover, the method may include generating an EOR turn path based on the selected EOR turn path type for making an EOR turn between an end point of the first path and a start point of a second path extending across the work area, the EOR turn path being associated with a speed profile. Additionally, the method may include automatically controlling a speed system of the agricultural vehicle to execute the speed profile as the agricultural vehicle moves along the EOR turn path.

### FIELD OF THE INVENTION

The present disclosure relates generally to guidance systems for agricultural vehicles and, more particularly, to systems and methods for automatically implementing end-of-row turns for an agricultural vehicle, such as an agricultural sprayer.

### BACKGROUND OF THE INVENTION

Various agricultural vehicles are well known for use with performing agricultural operations within a field. For instance, agricultural sprayers apply an agricultural substance (e.g., a pesticide, a nutrient, and/or the like) onto crops and/or a ground surface as the sprayer is traveling across a field. To facilitate such travel, sprayers are configured as self-propelled vehicles or implements towed behind an agricultural tractor or other suitable work vehicle. Traditionally, agricultural sprayers (or the vehicles towing a sprayer implement) have been manually operated by the operator. That is, the steering and speed of an agricultural sprayer have been controlled by an operator driving the sprayer. Recent developments integrating GPS-based navigation systems into agricultural vehicle control systems have enabled automatic or semi-automatic steering modes. For example, some agricultural sprayers may include a control system configured to automatically direct the sprayer to follow a path between, over, or adjacent to rows in a field. For many such control systems, end-of-row turns are executed manually. For example, when the agricultural sprayer reaches the end of a first swath or row, the operator raises, turns off, or otherwise disengages the agricultural implement; the operator then manually controls the speed and steering of the agricultural sprayer to guide the vehicle through the end-of-row turn connecting the end of the first swath to the beginning of a second swath or row. The operator then lowers, turns on, or otherwise engages the agricultural implement and an automatic or semi-automatic control system guides the agricultural sprayer along the second path.

To alleviate fatigue during such manual operation, more recent vehicle control systems have been developed that include algorithms configured to automatically generate a turn path for executing an end-of-row turn. However, to date, such algorithms have focused on simply ensuring that a given end-of-row turn can be achieved based on the vehicle's current speed. Such control generally limits the efficiency of the end-of-row turns.

Accordingly, an improved system and method for automatically implementing end-of-row turns with an agricultural sprayer or other agricultural vehicles would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a method for implementing end-of-row (EOR) turns within a field. The method includes receiving, with a computing device, an input associated with a selection of a selected EOR turn path type of a plurality of EOR turn path types associated with executing EOR turns for an agricultural vehicle within the field. The method further includes controlling, with the computing device, an operation of the agricultural vehicle such that the agricultural vehicle is traversed across a first path extending across a work area of the field during the performance of an agricultural operation. Moreover, the method includes generating, with the computing device, an EOR turn path based on the selected EOR turn path type for making an EOR turn between an end point of the first path and a start point of a second path extending across the work area, where the EOR turn path is associated with a speed profile. Additionally, the method includes automatically controlling, with the computing device, a speed system of the agricultural vehicle to execute the speed profile associated with the EOR turn path as the agricultural vehicle moves along the EOR turn path.

In another aspect, the present subject matter is directed to a system for implementing end-of-row (EOR) turns within a field. The system may include an agricultural vehicle and a computing system provided in operative association with the agricultural vehicle, where the computing system includes a processor and associated memory. The memory stores instructions that, when executed by the processor, configure the computing system to receive an input associated with a selection of a selected EOR turn path type of a plurality of EOR turn path types associated with executing EOR turns for an agricultural vehicle within the field. The instructions further configure the computing system to control an operation of the agricultural vehicle such that the agricultural vehicle is traversed across a first path extending across a work area of the field during a performance of an agricultural operation. Moreover, the instructions configure the computing system to generate an EOR turn path based on the selected EOR turn path type for making an EOR turn between an end point of the first path and a start point of a second path extending across the work area, where the EOR turn path is associated with a speed profile. Additionally, the instructions configure the computing system to automatically control a speed system of the agricultural vehicle to execute the speed profile associated with the EOR turn path as the agricultural vehicle moves along the EOR turn path.

In a further aspect, the present subject matter is directed to an agricultural sprayer. The agricultural sprayer includes a chassis, an operator's cab supported by the chassis, the operator's cab including a user interface housed therein, a boom assembly coupled to the chassis, a speed system configured to propel the agricultural sprayer across a field, a steering system configured to adjust a travel direction of the sprayer relative to the field, and a controller including a processor and associated memory. The memory stores instructions that, when executed by the processor, configure the controller to control the user interface to display a plurality of EOR turn path types associated with executing EOR turns within the field. The instructions further configure the controller to receive an input from an operator of the agricultural sprayer via the user interface, the input being indicative of a selection of a selected EOR turn path type of the plurality of EOR turn path types. Further, the instructions configure the controller to control an operation of the steering system such that the agricultural sprayer is traversed across a first path extending across a work area of the field during the performance of a spraying operation. Moreover, the instructions configure the controller to generate an EOR turn path based on the selected EOR turn path type for making an EOR turn between an end point of the first path and a start point of a second path extending across the work area, where the EOR turn path is associated with a speed profile. Additionally, the instructions configure the controller to automatically control the speed system to execute the speed profile associated with the EOR turn path as the steering system is controlled to guide the agricultural sprayer along the EOR turn path.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural sprayer in accordance with aspects of the present subject matter;

FIG. 2 illustrates a schematic view of one embodiment of a control system suitable for use with an agricultural sprayer in accordance with aspects of the present subject matter, particularly illustrating one embodiment of sub-systems that can be utilized to automatically generate an end-of-row turn path and subsequently execute an end-of-row turn along such path;

FIGS. 3A-3D illustrate schematic views of example field maps showing an agricultural sprayer within a field in accordance with aspects of the present subject matter, particularly illustrating end-of-row turn paths defined between two guidance lines displayed on the map; and

FIG. 4 illustrates a flow diagram of one embodiment of a method for implementing end-of-row turns for agricultural sprayers in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for implementing end-of-row (EOR) turns with agricultural vehicles, such as agricultural sprayers. Specifically, in several embodiments, a computing system associated with an agricultural sprayer may be configured to provide an operator with several default or predetermined EOR turn path types for making a turn between an end point of a first path and a start point of a second path within a field in which the sprayer is configured to perform an agricultural operation (e.g., spraying). For example, the EOR turn path types may include an omega turn path type, an arcuate turn path type, a P-turn path type, a rectangular turn path type, and/or the like. Upon selection by an operator of one of the EOR turn path types, the computing system may generate an EOR turn path for turning the sprayer between the paths based on the selected EOR turn path type. When generating the EOR turn path, a particular speed profile associated with the EOR turn path is also generated. The speed profile generally defines a speed(s) at which the sprayer will be driven when executing the EOR turn along the EOR turn path. Once the EOR turn path and associated speed profile are generated, the computing system may, in several embodiments, be configured to automatically control a speed system of the agricultural sprayer according to the speed profile as the sprayer moves along the EOR turn path to help execute the associated EOR turn more effectively and/or efficiently.

It should be appreciated that, for purposes of discussion, the present subject matter will generally be described herein with reference to use of the disclosed systems and methods in association with agricultural sprayers. However, in general, the present subject matter may be utilized for automatically implementing EOR turns in association with any other suitable agricultural vehicles, such as tractors, harvesters, windrowers, and/or the like.

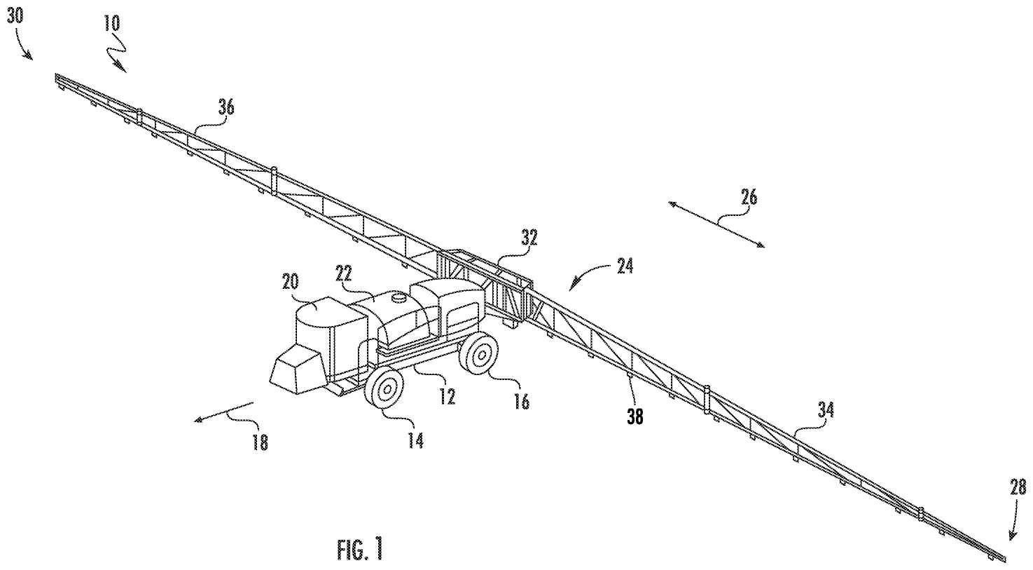

Referring now to the drawings, FIG. 1 illustrates a perspective view of one embodiment of an agricultural sprayer 10 in accordance with aspects of the present subject matter. In the illustrated embodiment, the agricultural sprayer 10 is configured as a self-propelled agricultural sprayer. However, in alternative embodiments, the agricultural sprayer 10 may be configured as any other suitable agricultural vehicle that dispenses an agricultural fluid (e.g., a pesticide or a nutrient) while traveling across a field, such as an agricultural tractor and an associated implement (e.g., a towable sprayer, an inter-seeder, a side-dresser, and/or the like).

As shown in FIG. 1, the agricultural sprayer 10 includes a frame or chassis 12 configured to support or couple to a plurality of components. For example, a pair of steerable front wheels 14 and a pair of driven rear wheels 16 may be coupled to the frame 12. The wheels 14, 16 may be configured to support the agricultural sprayer 10 relative to the ground and move the sprayer 10 in the travel direction 18 across the field. Furthermore, the frame 12 may support an operator's cab 20 and a tank 22 configured to store or hold an agricultural fluid, such as a pesticide (e.g., a herbicide, an insecticide, a rodenticide, and/or the like), a fertilizer, or a nutrient. However, in alternative embodiments, the sprayer 10 may include any other suitable configuration. For example, in one embodiment, the front wheels 14 of the sprayer 10 may be driven in addition to or in lieu of the rear wheels 16.

Additionally, the sprayer 10 may include a boom assembly 24 mounted on the frame 12. In general, the boom assembly 24 may extend in a lateral direction 26 between a first lateral end 28 and a second lateral end 30. In one embodiment, the boom assembly 24 may include a center section 32 and a pair of wing sections 34, 36. As shown in FIG. 1, a first wing section 34 extends outwardly in the lateral direction 26 from the center section 32 to the first lateral end 28. Similarly, a second wing section 36 extends outwardly in the lateral direction 26 from the center section 32 to the second lateral end 30. A plurality of nozzles 38 may be mounted on the boom assembly 24 and configured to dispense the agricultural fluid stored in the tank 22 onto the underlying plants and/or soil. However, in alternative embodiments, the boom assembly 24 may include any other suitable configuration.

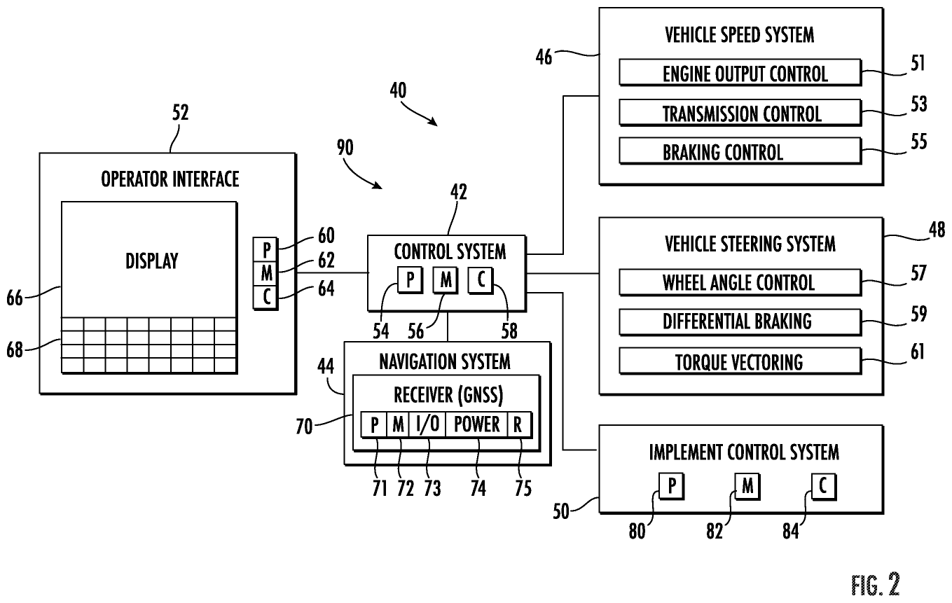

Referring now to FIG. 2, a schematic view of one embodiment of a control system 40 suitable for use with the agricultural sprayer 10 shown in FIG. 1 is illustrated in accordance with aspects of the present subject matter. In the illustrated embodiment, the control system 40 includes a vehicle control system 42, a navigation system 44, a vehicle speed system 46, a vehicle steering system 48, an implement control system 50, and an operator interface 52. However, it should be understood that other embodiments of the control system 40 may include different elements in alternative combinations.

In several embodiments, the vehicle controller or control system 42 may include one or more computing devices and/or other computer-related components, such as one or more processors 54, one or more memory components 56, and communication circuitry 58. The processor(s) 54 may include one or more general-purpose processors, one or more application specific integrated circuits, one or more field programmable gate arrays, and/or the like. The memory 56 may be any tangible, non-transitory, computer readable medium that is capable of storing instructions executable by the processor 54 and/or data that may be processed by the processor 54. In other words, the memory 56 may include volatile memory, such as random-access memory, or non-volatile memory, such as hard disk drives, read-only memory, optical disks, flash memory, and the like. The communication circuitry 58 may be configured to receive inputs (e.g., feedback signals, sensor signals, etc.) and transmit outputs (e.g., control signals, command signals, etc.) to other systems or sub-systems, such as the navigation system 44, the vehicle speed system 46, the vehicle steering system 48, the implement control system 50, and/or the operator interface 52.

The navigation system 44 may be in communication with the vehicle control system 42 (e.g., via the communication circuitry 58). The navigation system may, in one embodiment, include a Global Navigation Satellite System (GNSS) receiver 70 configured to communicate with two or more satellites in orbit (e.g., GPS, GLONASS, Galileo, BeiDou, etc.) to determine the location, heading, speed, etc. of the sprayer 10. The receiver 70 may include one or more computing devices and/or computer-related components, such as one or more processors 71, one or more memory components 72, input/output channels 73, a power supply 74, and radio circuitry 75. The processors 71 may run software stored on the memory component(s) 72 to compute the position of the sprayer 10 (or boom assembly 24). Based on the computed position, the processor may also determine, for example, the vehicle's heading, speed, etc. In view of the information received from the navigation system 44, the vehicle control system 42 may be configured to determine (e.g., via the processor 54) the relative proximity of the agricultural sprayer 10 (e.g., the boom assembly 24) to one or more rows, swaths or guidance lines, one or more field boundaries, etc. Additionally, based on the vehicle position received from the navigation system 44, the vehicle control system 42 may also determine a path across a field, an end-of-row turn path from one swath to another, or a path to the nearest swath, and subsequently guide the agricultural sprayer 10 along such path.

The vehicle speed system 46 may be configured to control the speed of the agricultural sprayer 10 in the direction of travel 24. Control of the speed may be by control of a throttle, a clutch, brakes, a transmission, one or more other systems or sub-systems, or a combination thereof. In the illustrated embodiment, the speed control system 40 includes an engine output control system 51, a transmission control system 53, and a braking control system 55. The engine output control system 51 is configured to vary the output of an engine to control the speed of the sprayer 10. For example, the engine output control system 51 may vary a throttle setting of the engine, a fuel/air mixture of the engine, a timing of the engine, and/or any other suitable engine parameters to control engine output. In addition, the transmission control system 53 may adjust the gear selection within a transmission to control the speed of the sprayer 10. For example, the transmission control system 53 may allow for manual or automatic changing of gears or a gear ratio via the transmission as a way to control the speed of the sprayer 10. The transmission may include a number of fixed gear ratios or a continuously variable gear ratio. Furthermore, the braking control system 55 may adjust the braking force, thereby controlling the speed of the sprayer 10 (e.g., to slow the vehicle down at the end of a row in order to make a turn). While the illustrated vehicle speed system 46 includes the engine output control system 51, the transmission control system 53, and the braking control system 55, it should be appreciated that alternative embodiments may include any of these sub-systems in any suitable combination. Further embodiments may include a vehicle speed system 46 having other and/or additional sub-systems to facilitate adjusting the speed of the sprayer 10. The vehicle speed system 46 may be controlled by the operator in a manual mode of operation. In an automatic or semi-automatic mode of operation, the vehicle speed system 46 may be controlled automatically or semi-automatically by the vehicle control system 42.

Referring still to FIG. 2, the vehicle steering system 48 may control the steering of the agricultural sprayer 10 to adjust a heading or travel direction of the agricultural sprayer 10 relative to the field. In the illustrated embodiment, the vehicle steering system 48 includes a wheel angle control system 57, a differential braking system 59, and a torque vectoring system 61. The wheel angle control system 57 may automatically rotate one or more wheels or tracks of the sprayer 10 (e.g., via mechanical or hydraulic actuators) to steer the sprayer 10 along a path. By way of example, the wheel angle control system 57 may rotate front wheels/tracks, rear wheels/tracks, and/or intermediate wheels/tracks of the sprayer 10, either individually or in groups. In some embodiments, steering may be accomplished by varying the speed of wheels or tracks on either side of the vehicle. In some embodiments, the wheel angle control system 57 may be hydraulically actuated rather than, or in addition to, being mechanically actuated (e.g., via gears). A hydraulically actuated steering system 48 may enable the agricultural sprayer 10 to turn without corresponding movement of a steering wheel (or other steering input device) inside the cab 16 during an automatic or semi-automatic drive mode. The differential braking system 59 may independently vary the braking force on each side of the sprayer 10 to direct the sprayer 10 along the path. Similarly, the torque vectoring system 61 may differentially apply torque from the engine to wheels and/or tracks on each side of the sprayer 10, thereby directing the sprayer 10 along the path. While the illustrated vehicle steering system 48 includes the wheel angle control system 57, the differential braking system 59, and the torque vectoring system 61, it should be appreciated that alternative embodiments may include any of these sub-systems in any suitable combination.

Further embodiments may include a vehicle steering system 48 having other and/or additional sub-systems to facilitate directing the sprayer 10 along a desired path (e.g., an articulated steering system, etc.). The vehicle steering system 48 may be controlled by the operator in a manual mode of operation. In an automatic or semi-automatic mode of operation, the vehicle steering system 48 may be controlled automatically by the vehicle control system 42. For example, in one semi-automatic mode of operation, the steering system 48 may be automatically controlled by the vehicle control system 42, and the vehicle speed system 46 may be controlled by the operator. In another semi-automatic mode of operation, the steering system may be manually controlled by the operator, and the vehicle speed system 46 may be automatically controlled by the vehicle control system 42. In a fully automatic mode of operation, both the vehicle speed system 46 and the vehicle steering system 48 may be controlled by the control system 42. As will be described below, in several embodiments, the control system 42 may be configured to control both the vehicle speed system 46 and the vehicle steering system 48 in the fully automatic mode when implementing EOR turns with the sprayer 10.

The implement control system 50 may be used to control one or more aspects of the operation of the boom assembly 24. For example, the implement control system 50 may raise or lower the boom assembly 24, turn the boom assembly 24 on or off, or otherwise engage or disengage the boom assembly 24, control nozzle assemblies of the boom assembly 24, etc., and/or a combination thereof. As shown in FIG. 2, the implement control system 50 may include or more computing devices and/or other computer-related components, such as one or more processors 80, one or more memory components 82, and communication circuitry 84. The processor 80 may include one or more general-purpose processors, one or more application specific integrated circuits, one or more field programmable gate arrays, and/or the like. The memory 82 may be any tangible, non-transitory, computer readable medium that is capable of storing instructions executable by the processor 80 and/or data that may be processed by the processor 80. The memory 82 may include volatile memory, such as random-access memory, or non-volatile memory, such as hard disk drives, read-only memory, optical disks, flash memory, and the like. The communication circuitry 84 may be configured to receive inputs (e.g., feedback signals, sensor signals, etc.) and transmit outputs (e.g., control signals, command signals, etc.) to, for example, the vehicle control system 42 (e.g., (via the communication circuitry 58 of the vehicle control system 42). In some embodiments, the communication circuitry 58, 84 may communicate with various components within the system 10 wirelessly. Additionally, in some embodiments, the implement control system 50 and the vehicle control system 42 may be disposed within the same housing, may share processors 54, 80, memory components 56, 82, and/or communication circuitry 58, 84. In other embodiments, the implement control system 50 and the vehicle control system 42 may be disposed within the separate housings. In further embodiments, the vehicle control system 42 and the implement control system 50 may be the same component.

The operator or user interface 52 may be disposed inside the cab 16 of the sprayer 10 and may be configured to display information for, and receive inputs from, the operator. In the illustrated embodiment, the user interface 52 includes one or more computing devices and/or other computer-related components, such as one or more processors 60, one or more memory components 62, communication circuitry 64. The processor(s) 60 may include one or more general-purpose processors, one or more application specific integrated circuits, one or more field programmable gate arrays, or the like. The memory 62 may be any tangible, non-transitory, computer readable medium that is capable of storing instructions executable by the processor 60 and/or data that may be processed by the processor 60. The memory 62 may include volatile memory, such as random-access memory, or non-volatile memory, such as hard disk drives, read-only memory, optical disks, flash memory, and the like. The communication circuitry 64 may be configured to communicate with, for example, the vehicle control system 42 and/or the implement control system 50 (e.g., via the communication circuitry 58 of the vehicle control system 42 and/or the communication circuity 84 of the implement control system 50). In some embodiments, the communication circuitry 58, 64, 84 may communicate with various components within the system 10 wirelessly. In some embodiments, the operator interface 52 and one or both of the vehicle control system 42 and the implement control system 50 may be disposed within the same housing, may share processors 54, 60, 80, memory components 56, 62, 82, and/or communication circuitry 58, 64, 84. In other embodiments, such systems may be disposed within the separate housings. In further embodiments, the operator interface 52 and one or both of the vehicle control system 42 and the implement control system 50 may be the same component.

As shown in FIG. 2, the operator interface 52 includes a display 66 configured to display information related to the agricultural sprayer 10 to the operator. The display 66 may be a screen, an array of LEDs, a series of gauges, a combination thereof, and/or any other arrangement. The operator interface 52 also includes an operator input 68 that enables a user to input information. The operator input 68 may be a keyboard, a series of buttons, a joystick, a mouse, a track pad, etc. In some embodiments, the display 66 and the operator input 68 may be a single component (e.g., a touchscreen). Based on inputs received from the operator interface 52 and the navigation system 44, or other sensors disposed throughout the agricultural sprayer 10, as well as inputs that may be stored in the one or more memory components, the vehicle control system 42 may generate a path for the agricultural sprayer 10, and in some cases, automatically or semi-automatically control the various systems 46, 48, 50 to guide the sprayer 10 along the path.

It should be appreciated that, in several embodiments, the control system 40 may include a computing system 90 incorporating one or more computing or processor-based devices, including one or more of the computing devices and/or related systems described above. For instance, in one embodiment, the computing system 90 may include or incorporate one or more components of the vehicle control system 42, the navigation system 44, vehicle speed system 46, vehicle steering system 48, implement control system 50, and/or the operator interface 52, such as any of the processors, memory, communications circuitry, and/or any other computer-related components of such systems and/or sub-systems. In addition, the computing system 90 may include or may be communicatively coupled to one or more computing devices that are remote to the agricultural sprayer 10, such as one or more remote servers, base stations and/or the like. In such an embodiment, the vehicle-based or implement-based systems and/or sub-systems, such as the vehicle control system 42 and/or the like, may be configured to communicate with such remote computing devices over any suitable network, such as a wireless or wired network.

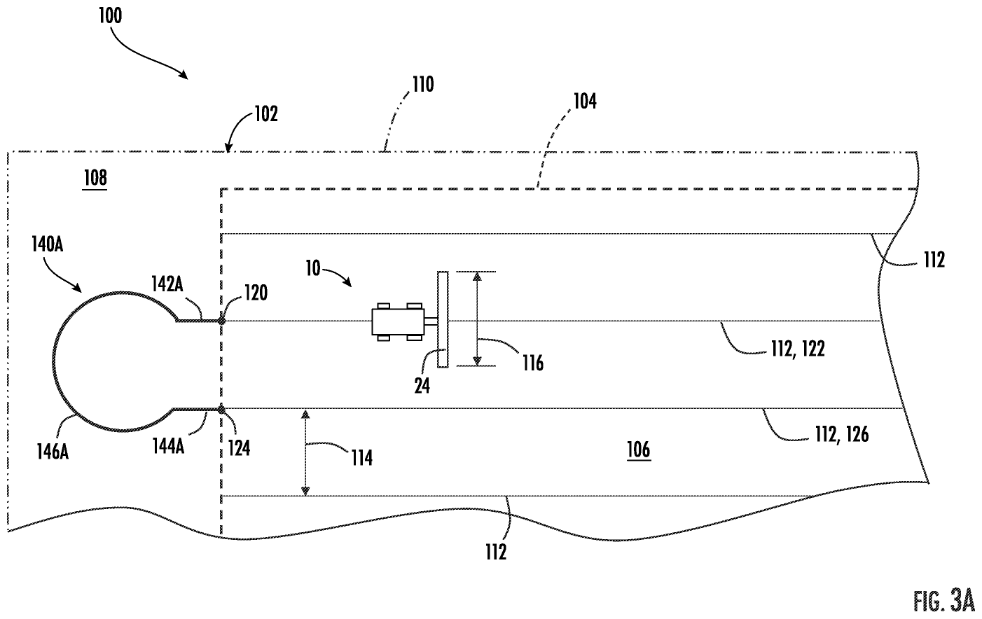

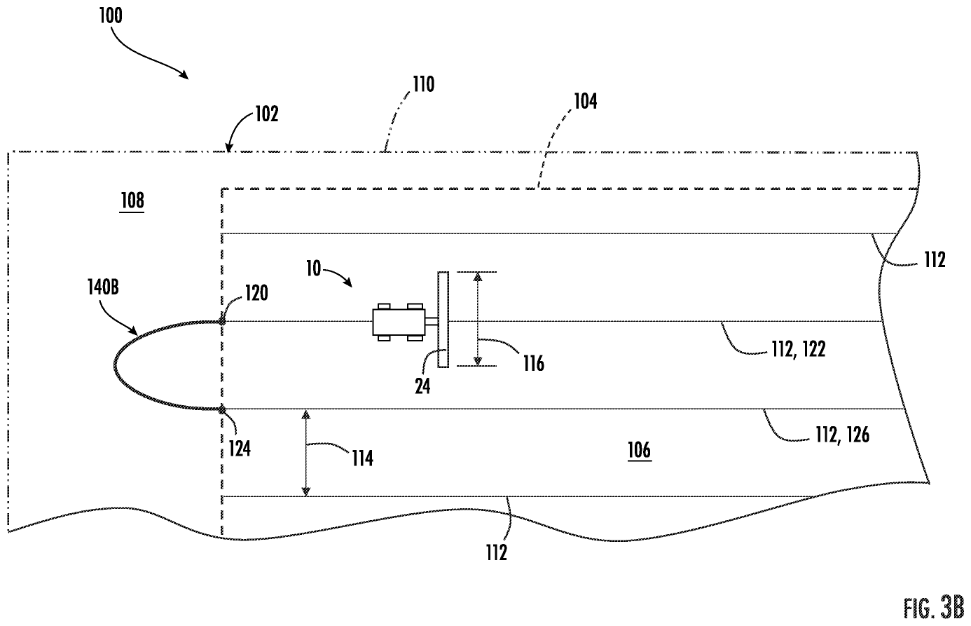

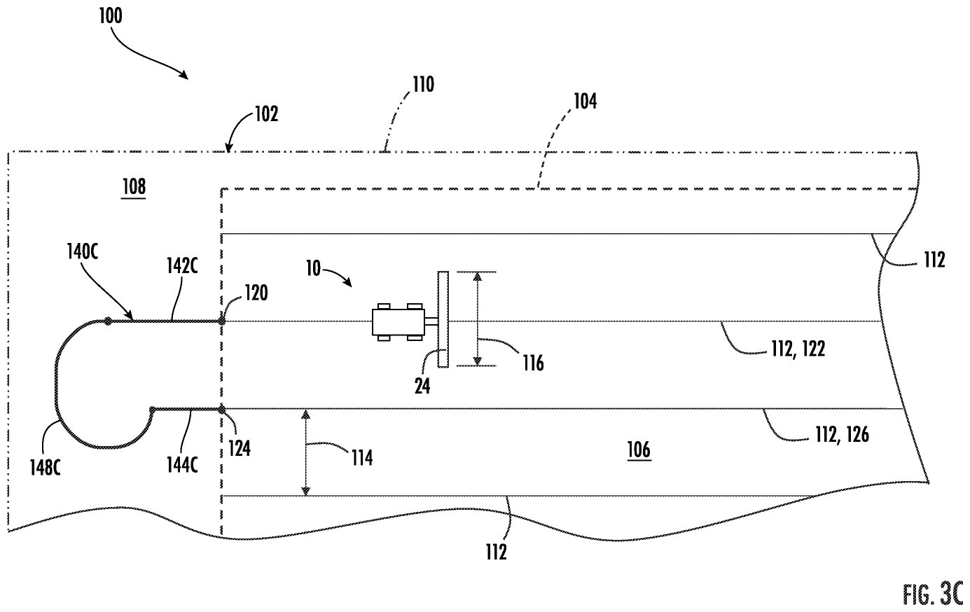

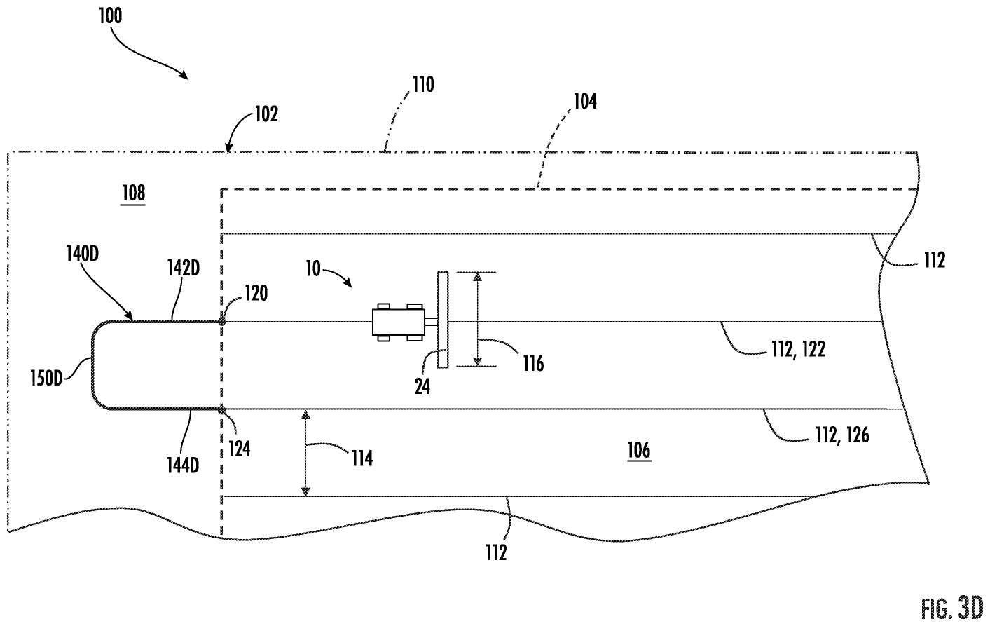

Referring now to FIGS. 3A-3D, schematic views of a portion of a field map 100 showing an agricultural sprayer 10 within a field 102 is illustrated in accordance with aspects of the present subject matter. In several embodiments, the field map 100 may be configured to be presented to the vehicle operator (e.g., via the display 66 of the operator interface 52) during the performance an agricultural operation within the field 102 (e.g., spraying). For instance, the field map 100 may be presented to the operator to display swath or guidance lines, end-of-row turn paths, and/or other relevant information as an agricultural operation is being performed within the field 102.

As shown, the field map 100 includes a work boundary 104 defined relative to the field 102 that outlines or otherwise forms the outer perimeter of the portion of the field 102 within which the agricultural operation is to be performed (i.e., a work area 106 of the field 102). The work boundary 104 may, in several embodiments, correspond to a virtual boundary that is created based on previously obtained data, such as position data (e.g., GPS location coordinates) and/or operator-provided data. For instance, in one embodiment, the operator may input data associated with the location of the work boundary 104 relative to the field 102, such as by drawing the work boundary 104 relative to the field 102 within the field map 100 using the operator interface 52 (or any other suitable interface) or by providing other input data associated with the location of the work boundary 104 within the field 102. The work boundary 104 may then be superimposed onto or otherwise displayed within the field map 100 relative to the underlying map data associated with the field 102. Additionally, as shown in FIGS. 3A-3D, the field 102 also includes a headlands area 108 disposed outside the work boundary 104 to facilitate end-of-row turns and/or the performance of other related actions. The headlands area 108 may, for example, be defined between the work boundary 104 of the field 102 and an outer field boundary 110 defining the outline or otherwise forming the outer perimeter of the field 102. The outer field boundary 110 may be a physical boundary for the field 102 (e.g., a fence, creek, ravine, road, etc.) or may correspond to a virtual boundary defining the outer perimeter of the field 102.

Moreover, as illustrated, the field map 100 also includes a plurality of virtual swath or guidance lines 112 extending across the work area 106. In several embodiments, the agricultural vehicle 12 may be automatically, semi-automatically, or manually controlled to follow the guidance lines 112 across the work area 106. Thus, the guidance lines 112 may generally correspond to the paths along which the agricultural sprayer 10 is configured to be guided or driven during the performance of an agricultural operation. In one embodiment, the guidance lines 112 may be evenly spaced apart across the work area 106 of the field 102 based on a predetermined swath width 114. For instance, the operator may be allowed to input the desired swath width or the swath width may be calculated by the vehicle control system 42 based on other available data (e.g., a lateral footprint 116 of the agricultural sprayer 10 corresponding to the maximum lateral width of the boom assembly 24). In one embodiment, the guidance lines 112 may be generated by the vehicle control system 42 based on the swath width 114 and an initial guidance line defined across the work area 106. For instance, the operator may be asked to provide input data associated with the location and/or shape (e.g., straight or curved) of an initial guidance line or the sprayer 10 may simply be driven across the work area 106 to establish an initial guidance line. The remainder of the guidance lines 112 may then be generated by creating paths or lines across the work area 106 that extend parallel to the initial guidance line and that are spaced apart from one another by the swath width 114. It should be appreciated that, although the guidance lines 112 are shown in FIG. 3 as being straight lines, the guidance lines 112 may, instead, be curved. Additionally, in some embodiments, the guidance lines 112 may be oriented non-parallel relative to one another.

Upon reaching an end point 120 of a first path 122 defined along one of the guidance lines 122 during the performance of an agricultural operation, the agricultural sprayer 10 may proceed to a starting point 124 of a second path 126 defined along a different guidance line 122 by following an end-of-row (EOR) turn path 140 during the execution of an EOR turn. For example, when the sprayer 10 (e.g., the front of the sprayer 10 or the boom assembly 24) reaches the end point 120 of the first path 122, the boom assembly 24 may be raised, turned off, or otherwise deactivated via the implement control system 50. This may be performed automatically by the vehicle control system 42 (and/or the implement control system 50) or by the operator via the operator interface 52. The sprayer 10 is then guided to follow the EOR turn path 140 to the starting point 124 of the second path 126. When the sprayer 10 (e.g., the front of the sprayer 10 or the boom assembly 24) reaches the starting point 124 of the second path 126 (or at a location immediately before or after such starting point 124), the boom assembly 24 is then lowered, turned on, and/or otherwise activated to allow for the continuation of the agricultural operation as the sprayer 10 proceeds across the work area 106 along the second path 126.

In several embodiments, the specific shape, length, etc. of the EOR turn path 140 generated may vary depending on a selected turn path type for executing EOR turns during the performance of the agricultural operation. For instance, in one embodiment, the operator may be allowed to select a given turn path type from a number of different predetermined or default EOR turn path types. In such an embodiment, the vehicle control system 42 may generally be configured to generate an EOR turn path 140 based on the selected turn path type. For example, an EOR turn path 140 between two different guidance lines 112 may be defined in a variety of different ways, such as along paths of different shapes and/or lengths. Such different path shapes/lengths can be characterized as different turn path types, thereby allowing an operator to select a desired turn path type based on, for instance, operator preferences, the lateral footprint 116 of the agricultural sprayer 10, available space within the headlands area 108, and/or the like.

For instance, in the embodiment illustrated by FIG. 3A, the EOR turn path 140A corresponds to an “omega” turn path type characterized by an omega-shaped path including first and second straight segments 142A, 144A extending from the end and start points 120, 124, respectively, of the associated paths 122, 124 and a semi-circular or arced segment 146A connecting the straight segments 142A, 144A. However, any other suitable turn path type may be used. For example, as shown in FIG. 3B, the EOR turn path 140B corresponds to an “arcuate” turn path type characterized by an arc-shaped path extending directly between the end and start points 120, 124, respectively, of the associated paths 122, 126. Alternatively, as shown in FIG. 3C, the EOR turn path 140C corresponds to a “P-turn” path type characterized by a p-shaped path including straight segments 142C, 144C extending from each associated path 122, 126 and an oblong or oval-like segment 148C connecting the straight segments 142C, 144C that projects outwardly to allow a wide turn along the outgoing side of the path (a “turn-in P-turn path type”) or along the incoming side of the path (a “turn-out P-turn path type”). Further, in embodiments such as the embodiment shown in FIG. 3D, the EOR turn path 140D corresponds to a “rectangular” turn path type characterized by a substantially rectangular-shaped path including straight segments 142D, 144D extending from each associated path 122, 126 and a straight connector segment 150D extending between the straight segments 142D, 144D with rounded-off corners at the transitions between the straight segments 142D, 144D and the straight connector segment 150D. However, it should be appreciated that such examples illustrated in FIGS. 3A-3D are not limiting. It should further be appreciated that by providing various options for different turn path types, the operator may select the desired turn path type (e.g., via the operator interface 52) to best suit the needs of the current operating conditions, based on one or more parameters of the agricultural sprayer 10 and/or in view of the agricultural operation being performed.

In several embodiments, the overall length/size of the EOR turn path 140 generated based on the selected turn path type may vary depending on numerous factors, such as the speed of the sprayer 10 as it enters the EOR turn, the minimum turning radius of the vehicle (e.g., as a function of speed), the lateral footprint 116 of the agricultural sprayer 10, and the distance between the end/start points 120, 124 of the associated guidance lines 112. Typically, such factors are sufficient to allow for suitable EOR turn paths to be generated by the vehicle control system 42. However, if the sprayer 10 is not driven at the speed with which the EOR turn is generated, the efficacy of the mapped EOR turn is significantly reduced.

In accordance with aspects of the present subject matter, the speed of the sprayer 10 is automatically controlled as the sprayer 10 is guided along the EOR turn path 140. More particularly, the speed system 46 of the sprayer 10 is automatically controlled by the control system 42 based at least in part on a speed profile associated with the EOR turn path 140. The speed profile is generally indicative of a preferred speed of the sprayer 10 for performing the EOR turn path 140. For instance, the speed profile may define a constant speed for performing the entire EOR turn or may define a speed for one or more of entering the EOR turn path 140 at the end point 120 of the first path 122, traversing each segment of the EOR turn path 140 (e.g., segments 142A, 144A, 146A of FIG. 3A, segments 142C, 144C, 148C of FIG. 3C, or segments 142D, 144D, 150D of FIG. 3D), and/or a speed for exiting the EOR turn path 140 at the start point 124 of the second path 126. Thus, the speed profile may define constant speed or may vary with time during execution of the EOR turn. Similar to the EOR turn path 140, the speed profile may be generated based at least in part on the speed of the sprayer 10 as it enters the EOR turn, the minimum turning radius of the sprayer 10 (e.g., as a function of speed), and/or any curvatures of the EOR turn path 140.

In several embodiments, a speed profile associated with an EOR turn path may generally prescribe lower speeds for curved segments and/or curved transition regions of the EOR turn path than for straight segments of the EOR turn path. For example, with reference to FIG. 3A, the speed profile may prescribe a lower overall speed when traversing the curved segment 146A of the EOR turn path 140A than when traversing the straight segments 142A, 144A of the EOR turn path 140A. As such, the average speed for executing the EOR turn may be higher than if a constant speed were used across the entire EOR turn path, which results in a faster time for completing the EOR turn.

Similarly, in several embodiments, a speed profile associated with an EOR turn path may prescribe lower speeds for curves with a smaller or tighter radius of curvature than curves with a larger or wider radius of curvature. For instance, with reference to FIG. 3B, the radius of curvature towards the exit point 120 of the first path 122 or the starting point 124 of the second path is wider than the radius of curvature at the vertex of the turn path 140B. As such, the speed profile may prescribe a lower speed closer to the vertex of the turn path 140B than closer to the points 120, 124. As such, the average speed for executing curved portions of the EOR turn may be kept as high as possible, without sacrificing safety, which results in a faster time for completing the EOR turn.

Additionally, in one embodiment, a speed profile associated with an EOR turn path may generally configured to gradually transition between speeds of different segments. For example, with reference to FIG. 3C, the speed profile may prescribe a first speed differential across the first straight segment 142C to decrease in speed from a higher speed (e.g., entrance speed) at the end point 120 of the first path 122 to a lower speed (e.g., the speed prescribed for the curved segment 148C) where the straight segment 142C meets the curved segment 148C. Similarly, the speed profile may prescribe a second speed differential across the second straight segment 144C to increase in speed from a lower speed (e.g., the speed prescribed for the curved segment 148C) where the curved segment 148C meets the straight segment 144C to a higher speed (e.g., exit speed) at the start point 124 of the second path 126. The speed differentials may be in any suitable manner. For instance, the speed differentials may be executed at a constant rate of change, at a varying rate of change, and/or the like and may be executed across the entire segment (e.g., at a generally lower rate of change) or across only a portion of the segment (e.g., at a generally higher rate of change). As such, the change in speed between different segments may be made less noticeable to an operator.

It should be appreciated that, as indicated above, the guidance of the sprayer 10 along the EOR turn path 140 is performed automatically by the vehicle control system 42. More particularly, the EOR turn path 140 may be used as a guidance line for controlling the operation of the vehicle steering system 48 to guide the sprayer 10 along the EOR turn path 140. In one embodiment, the vehicle control system 42 automatically controls both the vehicle speed system 46 according to the speed profile and the vehicle steering system 48 according to the EOR turn path 140. Alternatively, in some embodiments, the EOR turn may be performed semi-automatically by allowing the operator to manually steer the sprayer 10 along the defined EOR turn path 140 while the vehicle control system 42 automatically controls the vehicle speed system 46 according to the speed profile associated with the EOR turn path 140.

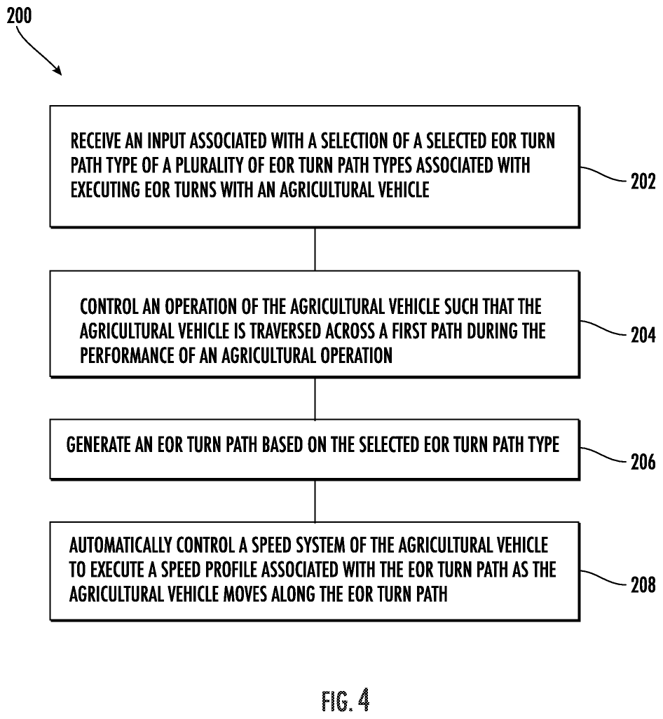

Referring now to FIG. 4, a flow diagram of one embodiment of a method 200 for implementing end-of-row (EOR) turns with an agricultural machine is illustrated in accordance with aspects of the present subject matter. For purposes of discussion, the method 200 will generally be described herein with reference to the agricultural sprayer 10 and system components described above with reference to FIGS. 1 and 2, and the EOR turn paths 140 described above with reference to FIGS. 3A-3D. However, it should be appreciated that the disclosed method 200 may be executed in association with any suitable agricultural vehicle having any other suitable configuration (including any suitable vehicle and/or implement configuration) and/or with any system having any other suitable system configuration and/or combination of system components. Additionally, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 4, at (202), the method 200 may include receiving an input indicative of a selected EOR turn path type of a plurality of EOR turn path types associated with executing EOR turns with an agricultural vehicle. For example, as indicated above, the control system 40 may receive an input from an operator via the user interface 52 (e.g., via the operator input(s) 68) indicating a selected EOR turn path type of the plurality of EOR turn path types associated with executing EOR turns with the agricultural vehicle 10.

Further, at (204), the method 200 may include controlling an operation of the agricultural vehicle such that the agricultural vehicle is traversed across a first path during the performance of an agricultural operation. For instance, as described above, an operation of the steering system 48 of the agricultural sprayer 10 is controlled such that the agricultural sprayer 10 is traversed across a first path 122 extending across a work area 106 of the field 102 during the performance of a spraying operation.

Moreover, at (206), the method 200 may include generating an EOR turn path based on the selected EOR turn path type. For example, as described above, an EOR turn path may be generated by the control system 40 (e.g., using the vehicle control system 42) based at least in part on the user-selected EOR path type of the plurality of EOR turn path types.

Additionally, at (208) the method 200 may include automatically controlling a speed system of the agricultural vehicle to execute a speed profile associated with the EOR turn path as the agricultural vehicle moves along the EOR turn path. For example, as discussed above, the control system 40 may automatically control the vehicle speed system 46 of the agricultural sprayer 10 to execute a speed profile associated with the EOR turn path as the agricultural sprayer 10 moves along the EOR turn path. In addition to such automatic control, the computing system 90 (e.g., via the operator interface 52) may be configured to display the EOR turn path to the machine operator. For instance, as indicated above, the EOR turn path may be displayed in association with a field map on the display 66 of the operator interface 52 to allow the operator to view the generated turn path.

It is to be understood that the steps of the method 200 are performed by the computing system 90 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 90 described herein, such as the method 200, is implemented in software code or instructions which are tangibly stored on a tangible computer readable medium. The computing system 90 loads the software code or instructions via a direct interface with the computer readable medium or via a wired and/or wireless network. Upon loading and executing such software code or instructions by the computing system 90, the computing system 90 may perform any of the functionality of the computing system 90 described herein, including any steps of the method 200 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for implementing end-of-row (EOR) turns within a field, the method comprising:
receiving, with a computing device, an input associated with a selection of a selected EOR turn path type of a plurality of EOR turn path types associated with executing EOR turns for an agricultural vehicle within the field;
controlling, with the computing device, an operation of the agricultural vehicle such that the agricultural vehicle is traversed across a first path extending across a work area of the field during the performance of an agricultural operation;
generating, with the computing device, an EOR turn path based on the selected EOR turn path type for making an EOR turn between an end point of the first path and a start point of a second path extending across the work area, the EOR turn path being associated with a speed profile; and
automatically controlling, with the computing device, a speed system of the agricultural vehicle to execute the speed profile associated with the EOR turn path as the agricultural vehicle moves along the EOR turn path.

2. The method of claim 1, further comprising automatically controlling, with the computing device, a steering system of the agricultural vehicle to guide the agricultural vehicle along the EOR turn path.

3. The method of claim 1, further comprising automatically controlling, with the computing device, a steering system of the agricultural vehicle to guide the agricultural vehicle along the first path, the first path corresponding to a guidance line across the field.

4. The method of claim 1, further comprising controlling, with the computing device, a user interface of the agricultural vehicle to display the plurality of EOR turn path types to an operator of the agricultural vehicle,
wherein receiving the input associated with the selection of the selected EOR turn path type comprises receiving an input from the operator associated with selecting one of the displayed EOR turn path types.

5. The method of claim 4, further comprising controlling, with the computing device, the user interface to display the EOR turn path to the operator.

6. The method of claim 1, wherein generating the EOR turn path comprises generating the EOR turn path based on the selected EOR turn path type and at least one of a current speed of the agricultural vehicle, a minimum turning radius of the agricultural vehicle, a lateral footprint of the agricultural vehicle, or a distance between the first and second paths.

7. The method of claim 1, wherein the plurality of EOR turn path types comprises two or more of an omega turn path type, an arcuate turn path type, a P-turn path type, and a rectangular turn path type.

8. The method of claim 1, further comprising determining the speed profile based at least in part on at least two of a current speed of the agricultural vehicle, a minimum turning radius of the agricultural vehicle, or a curvature of the EOR turn path.

9. A system for implementing end-of-row (EOR) turns within a field, the system comprising:
an agricultural vehicle; and
a computing system provided in operative association with the agricultural vehicle, the computing system including a processor and associated memory, the memory storing instructions that, when executed by the processor, configure the computing system to:
receive an input associated with a selection of a selected EOR turn path type of a plurality of EOR turn path types associated with executing EOR turns for an agricultural vehicle within the field;
control an operation of the agricultural vehicle such that the agricultural vehicle is traversed across a first path extending across a work area of the field during a performance of an agricultural operation;
generate an EOR turn path based on the selected EOR turn path type for making an EOR turn between an end point of the first path and a start point of a second path extending across the work area, the EOR turn path being associated with a speed profile; and
automatically control a speed system of the agricultural vehicle to execute the speed profile associated with the EOR turn path as the agricultural vehicle moves along the EOR turn path.

10. The system of claim 9, wherein the computing system is further configured to automatically control a steering system of the agricultural vehicle to guide the agricultural vehicle along the EOR turn path.

11. The system of claim 9, wherein the computing system is further configured to control a user interface of the agricultural vehicle to display the plurality of EOR turn path types,
wherein receiving the input associated with the selection of the selected EOR turn path type comprises receiving an input from the operator associated with selecting one of the displayed EOR turn path types.

12. The system of claim 11, further comprising controlling, with the computing system, the user interface to display the EOR turn path to the operator.

13. The system of claim 9, wherein generating the EOR turn path comprises generating the EOR turn path based on the selected EOR turn path type, and at least one of a current speed of the agricultural vehicle, a minimum turning radius of the agricultural vehicle, a lateral footprint of the agricultural vehicle, or a distance between the first and second paths.

14. The system of claim 9, wherein the plurality of EOR turn path types comprises two or more of an omega turn path type, an arcuate turn path type, a P-turn path type, and a rectangular turn path type.

15. The system of claim 9, wherein the computing system is further configured to determine the speed profile based at least in part on at least two of a current speed of the vehicle, a minimum turning radius of the agricultural vehicle, or a curvature of the EOR turn path.

16. An agricultural sprayer, comprising:
a chassis;
an operator's cab supported by the chassis, the operator's cab including a user interface housed therein;
a boom assembly coupled to the chassis;
a speed system configured to propel the agricultural sprayer across a field;
a steering system configured to adjust a travel direction of the sprayer relative to the field; and
a controller including a processor and associated memory, the memory storing instructions that, when executed by the processor, configure the controller to:
control the user interface to display a plurality of EOR turn path types associated with executing EOR turns within the field;
receive an input from an operator of the agricultural sprayer via the user interface, the input being indicative of a selection of a selected EOR turn path type of the plurality of EOR turn path types;
control an operation of the steering system such that the agricultural sprayer is traversed across a first path extending across a work area of the field during the performance of a spraying operation;
generate an EOR turn path based on the selected EOR turn path type for making an EOR turn between an end point of the first path and a start point of a second path extending across the work area, the EOR turn path being associated with a speed profile; and
automatically control the speed system to execute the speed profile associated with the EOR turn path as the steering system is controlled to guide the agricultural sprayer along the EOR turn path.

17. The agricultural sprayer of claim 16, wherein the controller is further configured to control the user interface to display the EOR turn path to the user.

18. The agricultural sprayer of claim 16, wherein generating the EOR turn path comprises generating the EOR turn path based on the selected EOR turn path type and at least one of a current speed of the agricultural sprayer, a minimum turning radius of the agricultural sprayer, a lateral footprint of the agricultural sprayer, or a distance between the first and second paths.

19. The agricultural sprayer of claim 16, wherein the plurality of EOR turn path types comprises two or more of an omega turn path type, an arcuate turn path type, a P-turn path type, and a rectangular turn path type.

20. The agricultural sprayer of claim 16, wherein the controller is further configured to determine the speed profile based at least in part on at least two of a current speed of the agricultural sprayer, a minimum turning radius of the agricultural sprayer, or any curvature of the EOR turn path.
